(19) United States
(12) Patent Application Publication
(10) Pub. No.: US 2012/0277909 A1
(43) Pub. Date: Nov. 1, 2012

(54) ROBOT CONTROL SYSTEM, ROBOT SYSTEM AND PROGRAM

(75) Inventor: Makoto OUCHI, Suwa (JP)

(73) Assignee: SEIKO EPSON CORPORATION, Tokyo (JP)

(21) Appl. No.: 13/455,226

(22) Filed: Apr. 25, 2012

(30) Foreign Application Priority Data
Apr. 28, 2011 (JP) 2011-100843

(51) Int. Cl. G05B 19/04

(52) U.S. Cl. 700/254; 901/48

(57) ABSTRACT

A robot control system includes a storage unit which stores a sequence command described by one or plural commands, a processing unit having an execution unit which carries out execution processing of the sequence command, and a robot control unit which controls a robot based on a result of processing by the processing unit. The storage unit stores plural normal operation sequence commands, and plural error processing operation sequence commands which have the same command system as the normal operation sequence commands. The execution unit, at the time of normal operation, executes the normal operation sequence commands, and at the time of error occurrence, executes an error processing operation sequence command corresponding to an error status.

### BACKGROUND

1. Technical Field

The present invention relates to a robot control system, a robot system, and a program and the like.

2. Related Art

Recently, industrial robots are widely used in various fields. In order to make such an industrial robot perform actions as a user intends, work contents to be executed need to be suggested to the robot.

The robot to which the work contents are suggested performs a work according to the work contents. However, in some cases, an error may occur during the work. Considering an example of a work in which a robot having an arm and a hand is made to grasp and move a workpiece, the robot may drop the grasped workpiece during the work or the arm may collide with an obstacle and cannot move to a desired position, thus causing an error.

When an error occurs in this manner, error processing needs to be executed to restore the robot and the workpiece to an appropriate state. The error processing may be, for example, stopping the robot, returning the robot to a standby position, re-executing the processing, omitting the processing, inputting a command, describing a work in advance, and so on. Here, inputting a command refers to a situation where the robot itself monitors a work operation and autonomously carries out error avoidance processing based on a result of error detection when an error is detected during the operation, as described in JP-A-2004-148493. Meanwhile, describing a work in advance refers to a situation where error processing is described in advance and the error processing is executed when an error occurs, as described in JP-A-2010-149255.

In the technique of JP-A-2004-148493, the operation needs to be monitored in order to detect an error. Also, the error avoidance processing needs to be inputted based on the result of error detection. Therefore, there is a problem that the monitoring and inputting lays a heavy burden.

In the technique of JP-A-2010-149255, since a work is described in advance, such a burden as in JP-A-2004-148493 does not occur. However, a technique for describing the work is difficult to understand and there is also a problem that whether an error can be dealt with properly by the described processing cannot be confirmed. Moreover, since only one type of alternative operation is prepared which is carried out in the case of an error, various errors cannot be dealt with.

### SUMMARY

An advantage of some aspects of the invention is to provide a robot control system, a robot system and a program and the like which are capable of describing error processing easily and flexibly using the same command system as a command used for description of a normal operation, as a command used for description of an error processing operation.

An aspect of the invention is directed to a robot control system including a storage unit which stores a sequence command described by one or plural commands, a processing unit having an execution unit which carries out execution processing of the sequence command stored in the storage unit, and a robot control unit which controls a robot based on a result of processing by the processing unit. The storage unit stores, as the sequence command, plural normal operation sequence commands, and plural error processing operation sequence commands described by the same command system as the commands used for description of the normal operation sequence commands. At the time of normal operation, the execution unit carries out execution processing of the normal operation sequence commands. At the time of error occurrence, the execution unit carries out execution processing of an error processing operation sequence command selected according to an error status, from the plural error processing operation sequence commands.

According to the aspect of the invention, a sequence command is described by one or plural commands, and as the sequence command, normal operation sequence commands and error processing operation sequence commands described in the same command system are described. At the time of normal operation, the normal operation sequence commands are executed. At the time of error occurrence, an error processing operation sequence command is executed. Thus, since error processing operation can be described similarly to normal operation, the processing can be shared and error processing can be carried out easily and flexibly.

In one aspect of the invention, the storage unit may store a command table which associates command information that is information related to the commands used for description of the sequence command, with a parameter indicating a processing target of the commands. When a condition command and the sequence command from among the commands have such a relation that the sequence command is executed by execution of one or a plurality of the condition commands, the storage unit may also store a sequence command table which associates the one or plurality of the condition commands with information related to the sequence command.

Thus, after the commands are stored in the form of a table in a database, the association between the sequence command and the condition command can be stored similarly in the form of a table in the database.

In one aspect of the invention, at the time of the normal operation, the processing unit may execute the one or plural condition commands constituting the normal operation sequence command, referring to the sequence command table and the command table. Also at the time of the error occurrence, the processing unit may execute the one or plural condition commands constituting the error processing operation sequence command, referring to the sequence command table and the command table.

Thus, whether it is when the normal operation sequence commands are described or when the error processing operation sequence commands are described, a common command group can be used as a condition command candidate and the same command system can be used for the commands used for description of the two sequence commands.

In one aspect of the invention, the storage unit may store first to M-th (M being an integer equal to or greater than 1) command records in the command table and may store first to N-th (N being an integer equal to or greater than 2) sequence command records in the sequence command table. The storage unit may store the command represented by a k-th (k being an integer 1≦k≦M) command record, as the condition command, in an i-th (i being an integer 1≦i≦N) sequence command record, and may store the command represented by the k-th command record, as the sequence command, in a j-th (j being an integer 1≦j≦N, i≠j) sequence command record.

Thus, one command can be use as the sequence command or can be used as the condition command, enabling the command structure to be hierarchized.

In one aspect of the invention, the storage unit may store, as the normal operation sequence command, a first normal operation sequence command including a first approach command, a grasp command and a move command, and may store, as the error processing operation sequence command, a first error processing operation sequence command including a second approach command for approaching a different position from the first approach command, the first approach command, the grasp command and the move command.

Thus, as a specific example, as error processing to deal with an error which occurs during processing of the normal operation sequence command including approach, grasp and move commands for a workpiece, the error processing operation sequence command including an approach command to a different position and the approach, grasp and move commands for the workpiece can be executed, and repetition of the same error can be restrained.

In one aspect of the invention, the robot control unit may output an error cord corresponding to the error status to the processing unit, and the execution unit may carry out execution processing of the error processing operation sequence command corresponding to the error code.

Thus, error processing corresponding to the error code becomes possible.

In one aspect of the invention, the processing unit may include an editing processing unit which carries out editing processing of the normal operation sequence command and the error processing operation sequence command.

Thus, the sequence commands can be edited.

In one aspect of the invention, the editing processing unit may use the command used in the normal operation sequence command or the error processing operation sequence command on which editing processing is carried out previously, in editing processing of the normal operation sequence command of this time or another error processing operation sequence command.

Thus, the commands used in the previous editing processing can be utilized in the subsequent editing processing and description of the sequence commands can be simplified.

In one aspect of the invention, the editing processing unit may use the command used in the normal operation sequence command on which editing processing is carried out previously, in editing processing of the error processing operation sequence command of this time.

Thus, the command can be utilized irrespective of whether the normal operation sequence command or the error processing operation sequence command is handled.

In one aspect of the invention, the editing processing unit may use the command used in the error processing operation sequence command on which editing processing is carried out previously, in editing processing of the normal operation sequence command of this time.

Thus, the command can be utilized irrespective of whether the normal operation sequence command or the error processing operation sequence command is handled.

In one aspect of the invention, the processing unit may include a simulation processing unit which carries out operation simulation processing of the robot control unit when the normal operation sequence command and the error processing operation sequence command are executed.

Thus, the sequence commands can be verified without using an actual machine of the robot.

In one aspect of the invention, the simulation processing unit may generate an error code corresponding to a pseudo error for confirmation of error processing.

Thus, as an error code is generated also in simulation processing, a shift can be made from the normal operation sequence command to the error processing operation sequence command and whether error processing is appropriate or not can be verified.

Another aspect of the invention is directed to a robot system including the above-described robot control system and a robot controlled by the robot control system.

Still another aspect of the invention is directed to a program causing a computer to function as a storage unit which stores a sequence command described by one or plural commands, a processing unit having an execution unit which carries out execution processing of the sequence command stored in the storage unit, and a robot control unit which controls a robot based on a result of processing by the processing unit. The storage unit stores, as the sequence command, plural normal operation sequence commands, and plural error processing operation sequence commands described by the same command system as the commands used for description of the normal operation sequence commands. At the time of normal operation, the execution unit carries out execution processing of the normal operation sequence commands. At the time of error occurrence, the execution unit carries out execution processing of an error processing operation sequence command selected according an error status, from the plural error processing operation sequence commands

### BRIEF DESCRIPTION OF THE DRAWINGS

The invention will be described with reference to the accompanying drawings, wherein like numbers reference like elements.

FIG. 1 shows an example of a system configuration according to an embodiment.

FIG. 2 shows a detailed example of the system configuration according to the embodiment.

FIGS. 3A and 3B show an example of a screen used for editing processing.

FIG. 4 shows an example of a data structure of a database stored in a storage unit.

FIG. 5 illustrates a hierarchical structure of command groups used in the embodiment.

FIGS. 6A to 6F illustrate a specific example of error processing to deal with an error during movement of a workpiece.

FIG. 7 is a flowchart for explaining overall processing according to the embodiment.

FIG. 8 is a flowchart for explaining execution processing of an operation instruction.

FIG. 9 is a flowchart for explaining execution processing of a rule (sequence command).

FIG. 10 is a flowchart for explaining simulation processing.

FIG. 11 shows another example of the system configuration according to the embodiment.

### DESCRIPTION OF EXEMPLARY EMBODIMENTS

Hereinafter, an embodiment will be described. The following embodiment is not intended to limit unduly the scope of the invention described in the accompanying claims. Also, not all the components of the configuration described in the embodiment are necessarily essential elements of the invention.

### 1. Technique of This Embodiment

When an error occurs while a robot is doing a work according to a suggested work content, error processing may be, for example, stopping the robot, returning the robot to a standby position, re-executing the processing, omitting the processing, inputting a command, describing a work in advance, and so on.

However, in the case of stopping the robot or returning the robot to the standby position, there is a problem that a desired operation is not completed. Also, in the case of re-executing the processing, no measures are taken to deal with the error and therefore a similar error is highly likely to occur again. In the case of omitting the processing, the processing lacks an operation process and therefore may not be completed properly.

As described in the foregoing JP-A-2004-148493, the work can be completed properly by inputting a command, but processes of monitoring the operation and inputting processing at the time of error occurrence are required. As described in the foregoing JP-A-2010-149255, the problem generated in inputting a command can be avoided by describing the work in advance. However, in the technique of JP-A-2010-149255, description of error processing is difficult and whether the described processing can properly deal with the error or not cannot be confirmed. Moreover, only one processing is described as an alternative processing and therefore it is difficult to deal with various errors.

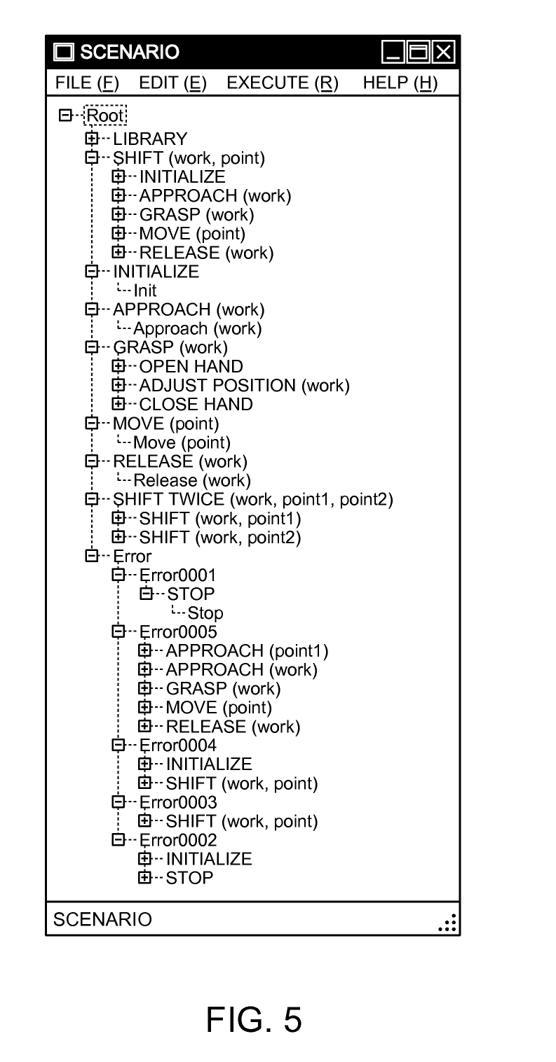

Thus, the present applicant proposes the following technique. First, processing at the time of error occurrence is described in advance as an error processing operation. In this description, the error processing operation and a normal operation are made describable by the same description technique, thus enabling easy and flexible description of error processing. Specifically, each processing (normal operation processing and error processing) is described based on rules. Here, a rule links one or plural condition commands with a sequence command that is regarded as executed when all the condition commands are executed. In the example of FIG. 5, a “Move” command is the sequence command and “Initialize”, “Approach”, “Grasp”, “Move” and “Release” commands are the condition commands.

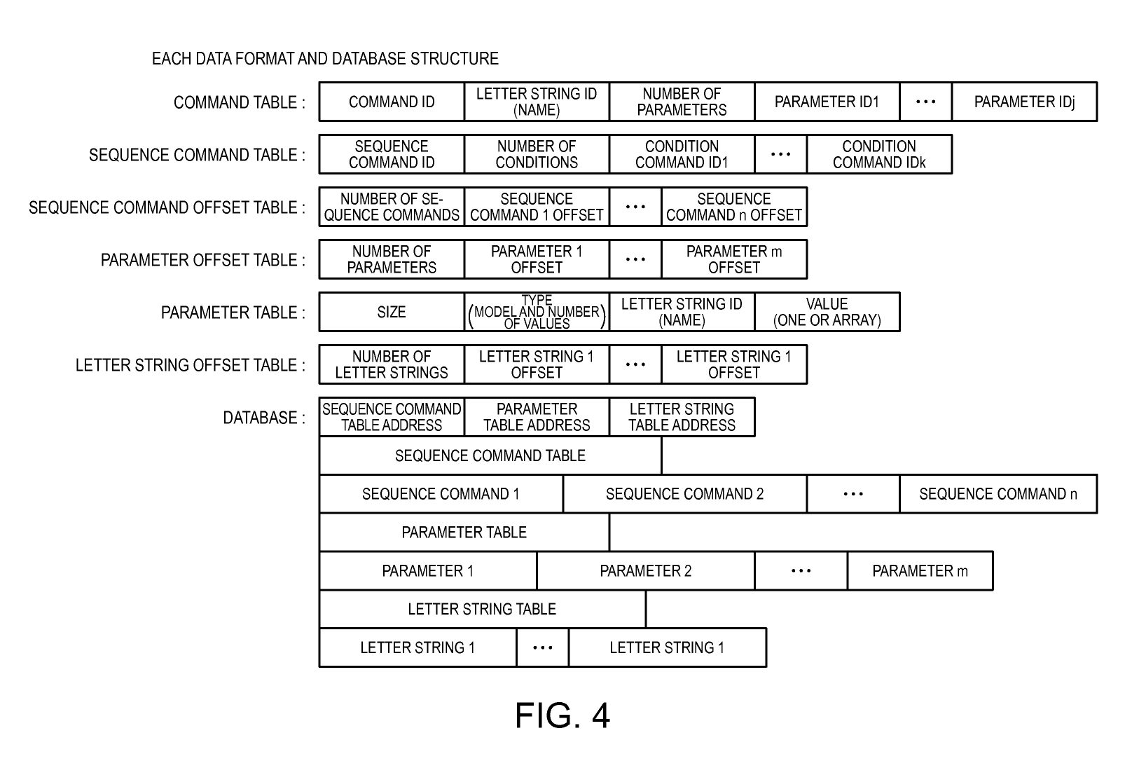

As described later with reference to FIG. 4, a command table is prepared in a database, and each command is stored as a record on the command table. The normal operation and the error processing operation are described in the form of rules by utilizing plural commands stored in the database as a common command group. That is, the “Initialize”, “Approach” and the like commands may be used in rules representing the normal operation or may be used in rules representing the error processing operation. As the command group is thus shared and used as common in the description of the normal operation and the error processing operation, the description of the error processing operation becomes easy. Also, rearrangement or the like on a command basis is possible and flexible description can be made.

When an error occurs during execution of the normal operation, an error code corresponding to the present error is generated and the error processing operation is executed according to the generated error code. That is, if plural error codes and error processing operations are prepared, error processing corresponding to the error is possible. Also, whether the error can be dealt with properly or not can be determined by carrying out a simulation with the described error processing operation.

Hereinafter, an example of a system configuration will be described first, and then the concept of commands, rules and the like used in this embodiment will be described with reference to FIG. 4, FIG. 5 and so on. After that, error processing will be described in detail using a specific example, and then the processing will be described in detail with reference to flowcharts.

### 2. Example of System Configuration

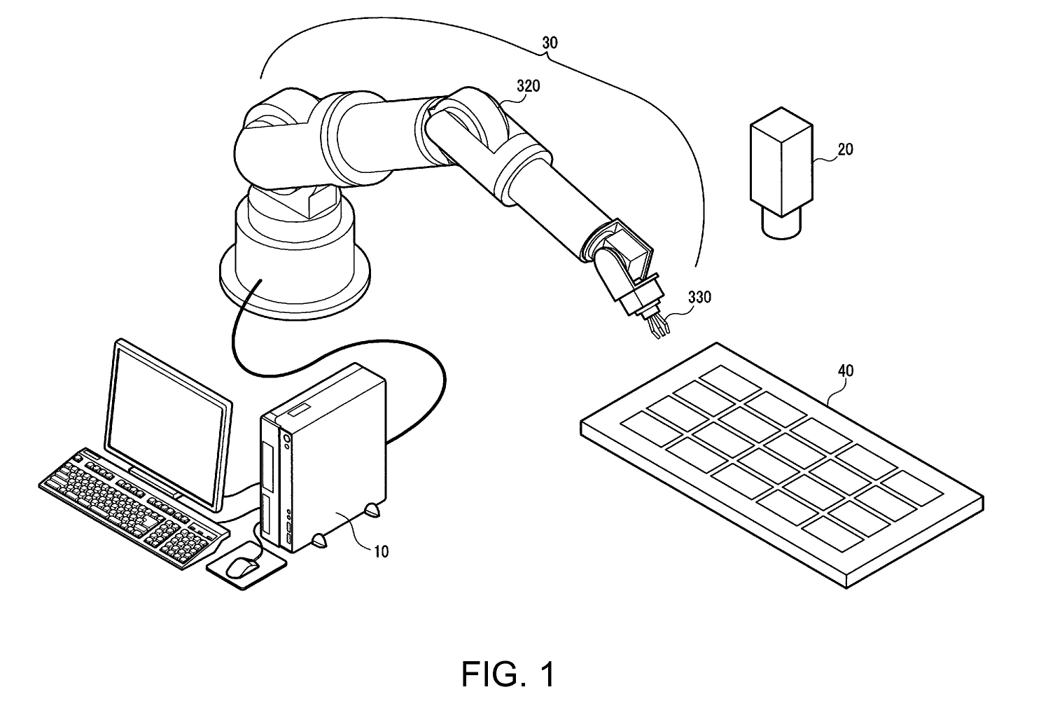

An example of the configuration of a robot system including a robot control system according to this embodiment will be described with reference to FIG. 1. The robot system includes an information processing device 10, an image pickup device 20, a robot 30, and a robot control device 50, not shown in FIG. 1. However, the robot system is not limited to the configuration of FIG. 1 and various modified embodiments are possible such as omitting one or some of the components or adding another component. The robot 30 has an arm 320 and a hand 330 and carries out processing according to an operation instruction from the information processing device 10. For example, the robot 30 processes a workpiece placed on a pallet 40. The image pickup device 20 is provided, for example, at a position where the image pickup device 20 can pick up an image of the workpiece (the image pickup device 20 may be provided immediately above the pallet or may be attached to the hand 330 of the robot 30). The image pickup device 20 mainly performs image pickup of the workpiece. The image pickup device 20 then detects information about the position, attitude and the like of the workpiece based on information of the picked-up image. The detected information may be sent, for example, to the information processing device 10 or the like, or may be sent directly to the robot 30. Since it suffices to be able to detect the information about the position, attitude and the like of the workpiece, other techniques than acquiring the picked-up image by the image pickup device 20 (for example, three-dimensional scan using a laser or the like) may also be used.

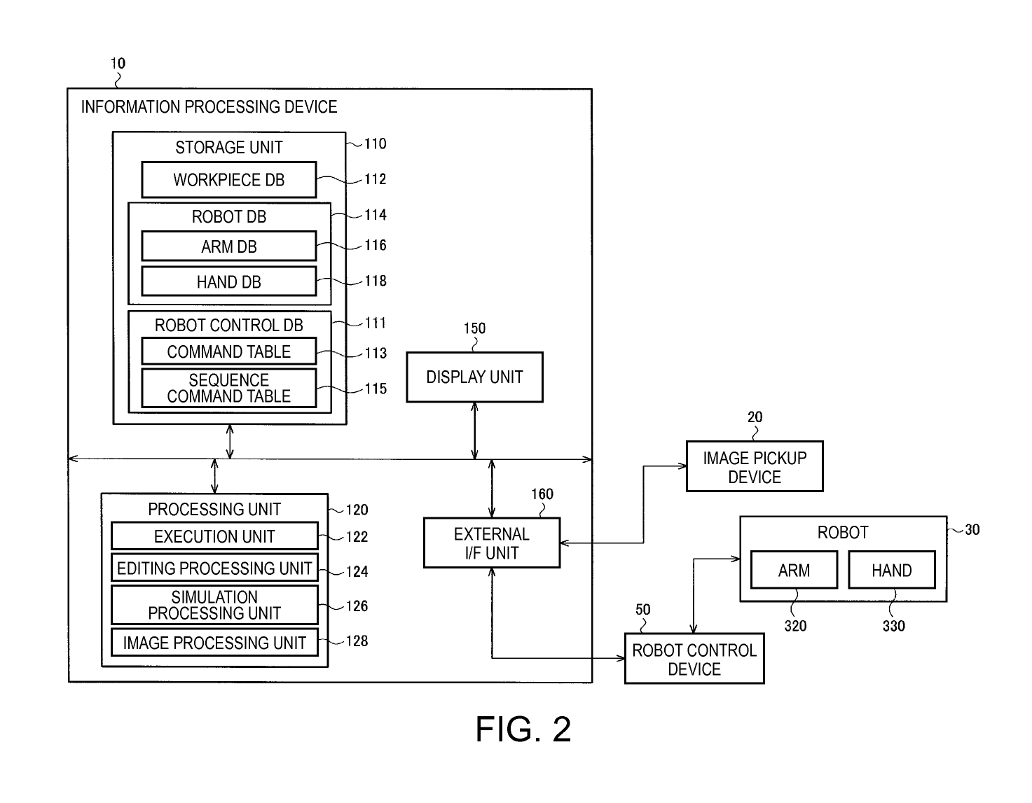

A specific configuration will be described with reference to FIG. 2. The information processing device 10 includes a storage unit 110, a processing unit 120, a display unit 150, and an external interface (I/F) unit 160.

The storage unit 110 stores a database and also serves as a work area for the processing unit 120 or the like. These functions can be realized by a memory such as a RAM or by an HDD (hard disk drive) or the like. The storage unit 110 includes a robot control database 111 (hereinafter database is referred to as DB when appropriate). Specifically, the robot control database 111 is a database which will be described later with reference to FIG. 4, and for example, includes a command table 113 and a sequence command table 115. The command table 113 stores data related to commands. The sequence command table 115 stores rules linking condition commands with sequence commands. The commands, condition commands, sequence commands, rules and the like will be described in detail later.

The storage unit 110 also includes a workpiece DB 112 and a robot DB 114. In the case where the robot has the arm 320 and the hand 330 as shown in FIG. 1, the robot DB 114 includes an arm DB 116 and a hand DB 118. In the case where the robot has plural arms, plural arm DBs 116 and hand DBs 118 may be provided. The workpiece DB 112 stores information about the size, shape, attitude and the like of the workpiece. The robot DB 114 stores data about the robot. Specifically, the arm DB 116 stores the shape, a moving range and the like of the arm. The hand DB 118 stores information about the shape, size and the like of the hand. However, the storage unit 110 is not limited to the configuration of FIG. 2 and various modified embodiments are possible such as omitting one or some of these components or adding another component.

The processing unit 120 carries out various kinds of processing based on data from the storage unit 110, or information or the like from the robot or the image pickup device received via the external I/F unit 160. The functions of the processing unit 120 can be realized by hardware including various processors (such as CPU) and ASIC (such as gate array), or by a program or the like.

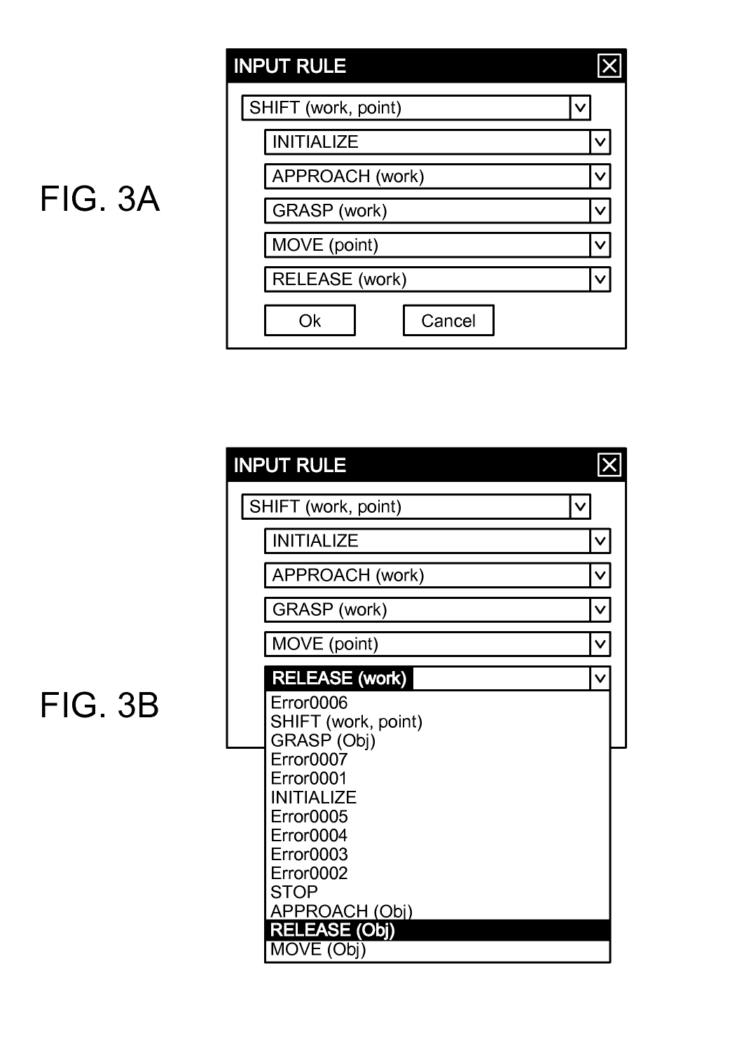

The processing unit 120 includes an execution unit 122, an editing processing unit 124, a simulation processing unit 126, and an image processing unit 128. The processing unit 120 is not limited to the configuration of FIG. 2 and various modified embodiments are possible such as omitting one or some of these components or adding another component. The execution unit 122 executes the sequence command that is edited by the editing processing unit 124 and stored in the storage unit 110. The sequence command is executed, for example, by giving a control instruction to the robot control device 50 via the external I/F unit 160. The editing processing unit 124 carries out editing processing of the rule (or the sequence command). The editing processing is carried out, for example, using a screen as shown in FIGS. 3A and 3B. The simulation processing unit 126 carries out simulation processing of execution of the sequence command that is edited by the editing processing unit 124 and stored in the storage unit. Therefore, specifically, the simulation processing unit 126 carries out a simulation or the like of processing in the robot control device 50. These units will be described in detail later. The image processing unit 128 acquires picked-up image information from the image pickup device 20 and carries out various kinds of image processing. Here the image processing unit 128 is provided in the processing unit 120 of the information processing device 10 but is not limited to this configuration. The image processing unit 128 may be provided inside the image pickup device 20.

The display unit 150 is for displaying various display screens and can be realized, for example, by a liquid crystal display or organic EL display.

The external I/F unit 160 is an interface for an user to enter an input or the like to the information processing device 10 and for accepting the information from the image pickup device 20 and the robot 30. For the user to enter an input or the like, the external I/F unit 160 may include a switch, button, keyboard, mouse or the like.

The image pickup device 20 is provided, for example, at a position where the image pickup device 20 can pick up an image of the workpiece, and mainly performs image pickup of the workpiece, as described above. In this embodiment, the image pickup device 20 sends picked-up image information directly to the information processing device 10 but is not limited to this configuration. For example, a portion of the processing unit 120 of the information processing device 10 (for example, the image processing unit 128 or the like) may be provided in the image pickup device 20. In such a case, information obtained after image processing of the picked-up image is outputted.

The robot arm 30 includes the arm 320 and the hand 330.

The robot control device 50 accepts information from the information processing device 10 and controls each part (the arm 320, the hand 330 and the like) of the robot 30. Specifically, the robot control device 50 performs control by sending a control signal to the robot 30. When an error occurs, the robot control device 50 outputs an error code to the processing unit 120.

### 3. Command and Sequence Command

### 3.1 Definition of Command and Sequence Command

Next, command, condition commands, sequence commands and the like used in this embodiment will be described. First, an example of the structure of the database in this embodiment will be described with reference to FIG. 4. The database (the robot control DB 111 in FIG. 2) includes a command table, a sequence command table, a sequence command offset table, a parameter table, a parameter offset table, a letter string offset table and the like.

The command table associates command ID with command name, the number of parameters and ID of each parameter. The sequence command table associates sequence command ID with the number of conditions and each condition command ID. The parameter table associates parameter ID, size, type, parameter name and parameter value. The sequence command offset table, the parameter offset table and the letter string offset table store an offset for finding an address at which an actual value is stored in the database.

A command in this embodiment refers to an operation instruction to the robot, which is stored as a record on the command table. Each command uses an arbitrary number of parameters. For example, a “Shift (work, point)” command uses work and point parameters. In this case, the command is to shift a workpiece expressed by the work parameter to a position expressed by the point parameter. There may be a command such as “Initialize” which uses no parameters. Additionally, there are “Approach (work)”, “Grasp (work)”, “Move (point)”, “Release (work)” and the like commands.

In this embodiment, one or plural condition commands are linked with a sequence command. This link is also referred to as a rule. The rule links the sequence command with the one or plural condition commands, and when all of the one or plural condition commands are executed, the sequence command is regarded as executed. It can also be said that the sequence command is described by the one or plural condition commands. As an example, according to a certain rule, a sequence command “Shift (work, point)” is linked with condition commands “Initialize”, “Approach (work)”, “Grasp (work)”, “Move (point)” and “Release (work)”. When “Initialize”, “Approach (work)”, “Grasp (work)”, “Move (point)” and “Release (work)” are executed in this order, it is considered that “Shift (work, point)” is executed. For both the sequence command and the condition commands used in these rules, commands included in a command group stored as a record on the command table are used.

Here, one command may be used as a sequence command in a certain rule and may be used as a condition command in another rule. For example, “Grasp (work)” used as a condition command for “Shift (work, point)” may be described as a sequence command in another rule. For example, linking a sequence command “Grasp (work)” with condition commands “Open hand”, “Adjust position (work)” and “Close hand” can be considered. As another example, “Shift (work, point)” may be used as a condition command. If there is a sequence command “Shift twice (work, point1, point2)” to shift one workpiece sequentially to two positions, this sequence command is linked with condition commands “Shift (work, point1)” and “Shift, (work, point2)”. That is, a command stored as a record on the command table may be used as a sequence command or may be used as a condition command. Commands can be hierarchized by an arbitrary configuration and operation instructions can be described flexibly.

In this embodiment, a normal operation and an error processing operation are described on a sequence command basis (on a rule basis) as described above. For example, one error processing operation corresponds to one sequence command, and this sequence command is called an error processing operation sequence command. Similarly, one normal operation corresponds to one sequence command, and this sequence command is called a normal operation sequence command. However, possible techniques are not limited to the above. For example, the concept of a scenario including plural sequence commands may be introduced and the normal operation and the error processing operation may be described by the one scenario. In the scenario of this case, too, each of the plural sequence commands constituting the scenario can be regarded as a condition command and an operation that is regarded as executed when each condition command is executed can be prescribed newly as a sequence command, thus enabling description by one sequence command. In this way, the normal operation and the error processing operation can be described by one sequence command. Thus, whether to describe the normal operation and the error processing operation by a sequence command or by a scenario is a matter of design. In this embodiment, either can be used.

### 3.2 Editing of Sequence Command by Editing Processing Unit

Rule editing processing by the editing processing unit 124 of the processing unit 120 will be described. As described above, since a rule links a sequence command with a condition command, the description of a rule is equivalent to processing to decide a sequence command and a condition command in the rule.

An example of a screen displayed on the display unit 150 of the information processing device 10 is shown in FIG. 3A. In the example of FIG. 3A, a format is adapted in which a sequence command is described in a first low, and one or plural condition commands are described in subsequent lows, to describe each command, a letter string equivalent to a command name may be inputted directly via the keyboard or the like, or a command may be selected using a drop-down menu as shown in FIG. 3B.

As a rule is described on a command basis, a system user no longer needs to consider robot control at low levels (for example, how much a manipulator should be operated, what degree a joint angle should be, and so on).

In the description of a command in the editing processing unit 124, a restriction may be provided to the effect that other commands than the command stored as a record on the command table 113 in the database stored in the storage unit 110 cannot be described. This is because the processing assumes that all executable commands are stored in advance as records on the command table 113. Even when an attempt to execute a command that is not stored in the database is made, what should be executed is not known and no processing is possible. Therefore, the restriction as described above can be expected to have a deterrent effect on the possibility of causing exceptional processing. When the drop-down menu is used, displayed command candidates may be limited to the commands stored in the database. When a letter string is inputted directly, the inputted letter string may be collated with the record in the database, and a warning may be displayed when a command name that is not stored is inputted.

### 4. Error Processing

### 4.1 Error Processing by Error Code

As described above, the normal operation is described by a sequence command, and the sequence command is linked with one or plural condition commands by a rule. Thus, when the normal operation is executed, the one or plural condition commands are executed in order.

When an error occurs during execution of the condition commands, processing of the normal operation is interrupted to shift to error processing. The error processing operation, too, is described by a sequence command as described above and is linked with a condition command by a rule. In this case, since plural error processing operation sequence commands can be described, which sequence command of the plural error processing operation sequence commands should be executed needs to be decided.

Thus, in this embodiment, an error code is generated when an error occurs. Specifically, the robot control device 50 generates an error code according to the content of the error and sends the error code to the processing unit 120 via the external I/F unit 160, thus switching the processing executed by the execution unit 122 of the processing unit 120 to the error processing operation corresponding to the error code. In this manner, an appropriate error processing operation sequence command according to the error status, of the prepared plural error processing operation sequence commands, can be selected and executed.

For example, as such error codes, five error codes 0001 to 0005 are prepared. Then, the error processing operation sequence command may be prepared for each error code, such as Error0001 as an error processing operation sequence command corresponding to 0001, and Error0002 as an error processing operation sequence command corresponding to 0002. The number of error processing operation sequence commands corresponding to one error code is not necessarily limited to one. Plural error processing operation sequence commands may be allocated to one error code, for example, executing Error0005 when the error code 0005 occurs for the first time, then executing Error0006, which is different from Error0005, when the error code 0005 occurs the second time, and so on.

### 4.2 Simulation Processing

In this embodiment, simulation processing of the error processing operation sequence command, of the sequence commands described by the above technique, can be carried out. Specifically, the simulation processing unit 126 of the processing unit 120 carries out a simulation of the control processing by the robot control device 50.

The simulation processing unit 126 carries out an execution simulation of the normal operation sequence command and randomly generates a pseudo error during the execution. The pseudo error is generated by generating an arbitrary error code with arbitrary timing.

As the error code is received, an error processing operation sequence command corresponding to the error code is executed. Considering the situation where the error occurs, the situation expected when the simulated normal operation sequence command is properly completed, and the situation as a result of simulation processing of the error processing operation sequence command, whether the simulated error processing operation sequence command is properly described is determined. This determination need not be autonomously made but can be made by the user.

For example, if the execution (simulation) of the error processing operation sequence command successfully results in the same situation as the situation that is expected on completion of the normal operation sequence command, this error processing operation sequence command can be determined as properly described. Also, error processing such as stopping the robot or returning the robot to the standby position or the like may be carried out. In such cases, it can be considered that the purpose of executing the error processing operation sequence command is to stop safely or the like, instead of achieving an effect equivalent to the execution of the normal operation sequence command. Thus, when such error processing operation sequence command is executed, whether the error processing operation sequence command is appropriate is determined, considering whether the robot needs to be stopped or the like in the situation at the time of error occurrence, whether the robot is safely stopped without damaging the robot, workpiece and other devices, by the execution of the error processing operation sequence command, and so on.

### 4.3 Specific Example

Next, the error processing will be described using a specific example. Here, a case where an error in the form of a workpiece falling off occurs when “Shift (work, point)” is being executed as a normal operation sequence command is considered.

In this case, the error code 0005 is sent back and the error processing operation sequence command Error0005 corresponding to the error code is executed. Here, an error processing operation that can result in a similar situation to the case where “Shift (work, point)” is completed is executed. As an example that can be expected in such a case, a sequence command to execute “Approach (point1)” first to shift the robot to a point 1 that is a different position from a result of “Initialize”, and then execute “Approach (work)”, “Grasp (work)”, “Move (point)” and “Release (work)”, can be employed, as shown by Error0005 in FIG. 5.

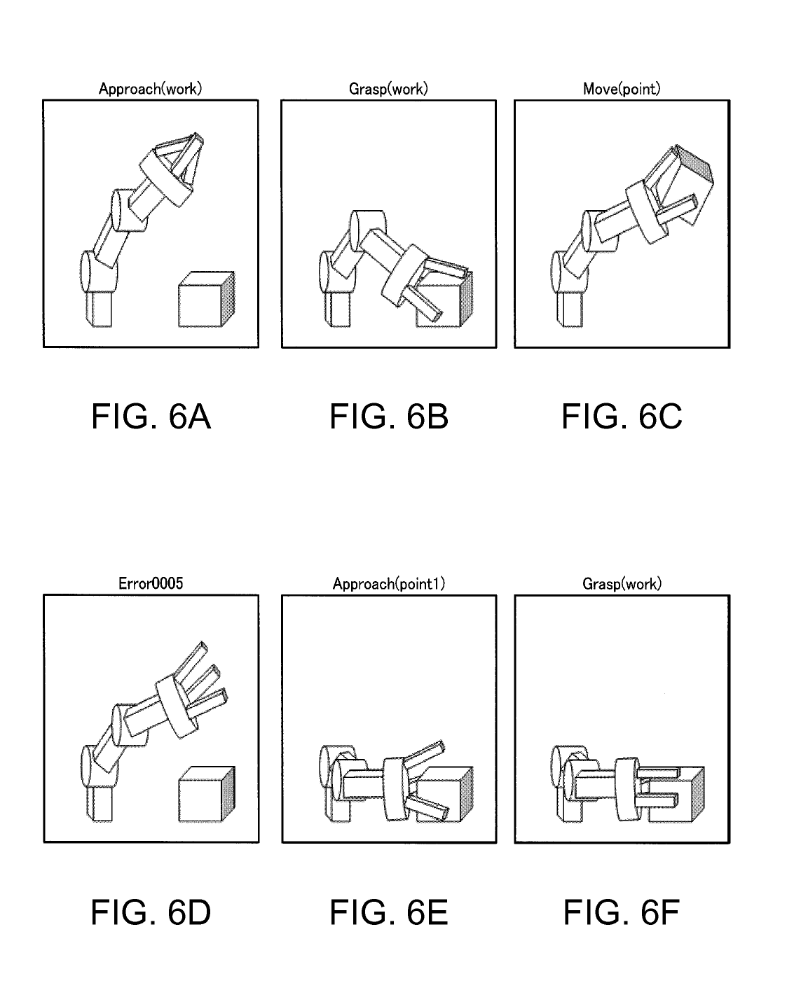

That is, the robot approaches the workpiece from above, which is an initial position (a standby position) of the robot, as shown in FIG. 6A. The robot then grasps the workpiece from above, as shown in FIG. 6B. It is assumed that while the robot is shifting the workpiece as shown in FIG. 6C, an error in the form of the workpiece falling off occurs as shown in FIG. 6D. In this case, if the normal operation sequence command (the five condition commands including initialization) is simply executed again, the robot is expected to grasp and shift the workpiece from a similar angle and therefore the error is highly likely to occur again (the workpiece is likely to fall off) for the same reason, though depending on a spot where the workpiece falls. Thus, here, “Approach (point1)” is carried out first to shift the robot to the point 1 (here, down below as shown in FIG. 6E), and then “Approach (work)” is executed to grasp the workpiece from a lateral side, not from above, as shown in FIG. 6F. Thus, since the robot grasps the workpiece at a modified angle, at least the occurrence of the error for the similar reason to the previous error can be restrained.

As described above, the plural error processing operation sequence commands can be described in advance. Here, “Stop” as Error0001, “Initialize” and “Stop” as Error0002, “Shift (work, point)” as Error0003, and “Initialize” and “Shift (work, point)” as Error0004 are described, as shown in FIG. 5. For example, in a case where the robot collides with something and further shift or the like can gravely damage the robot and the like, calling Error0001 to stop the robot immediately can be considered. Meanwhile, even if stopping the robot is desired, when the robot can be returned to the initial position, Error0002 can be called. In some cases, making another attempt is important as a temporary measure. In such cases, Error0003 is called. Error0004 starts with “Initialize” before the condition command “Shift (work, point)” and therefore is not significantly different from Error0003 in this case. However, in other sequence commands, there may be cases where simply re-executing the operation is not successful because the position of the robot is different from the initial position. In such cases, the robot can be returned to the initial position and then Error0004 for re-execution can be called.

### 5. Details of Processing

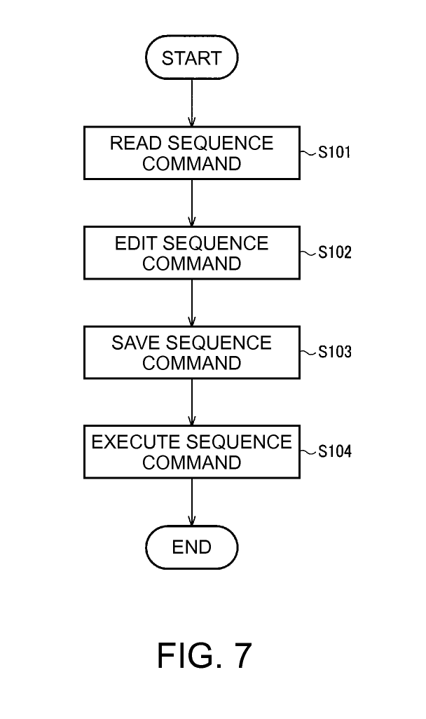

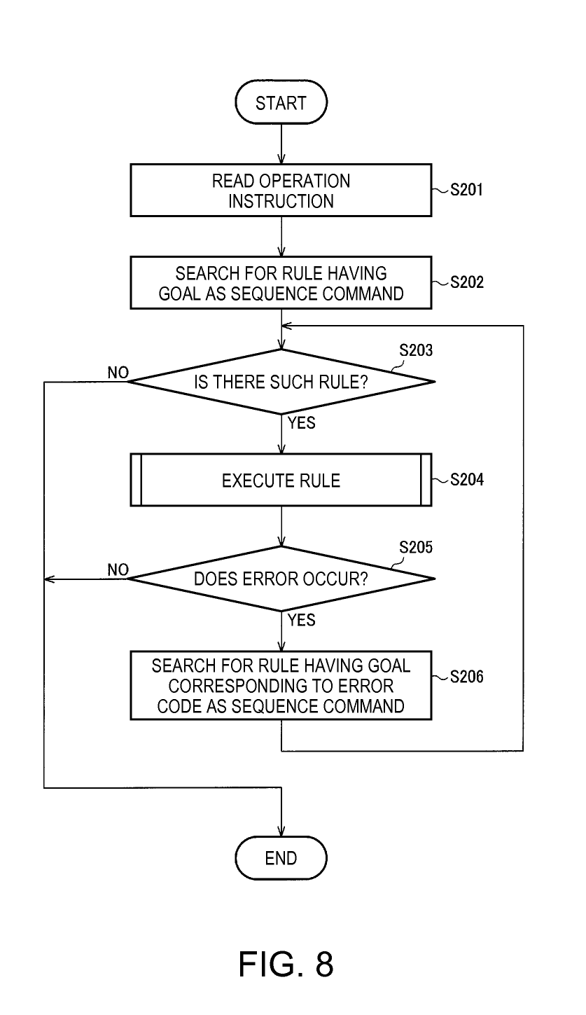

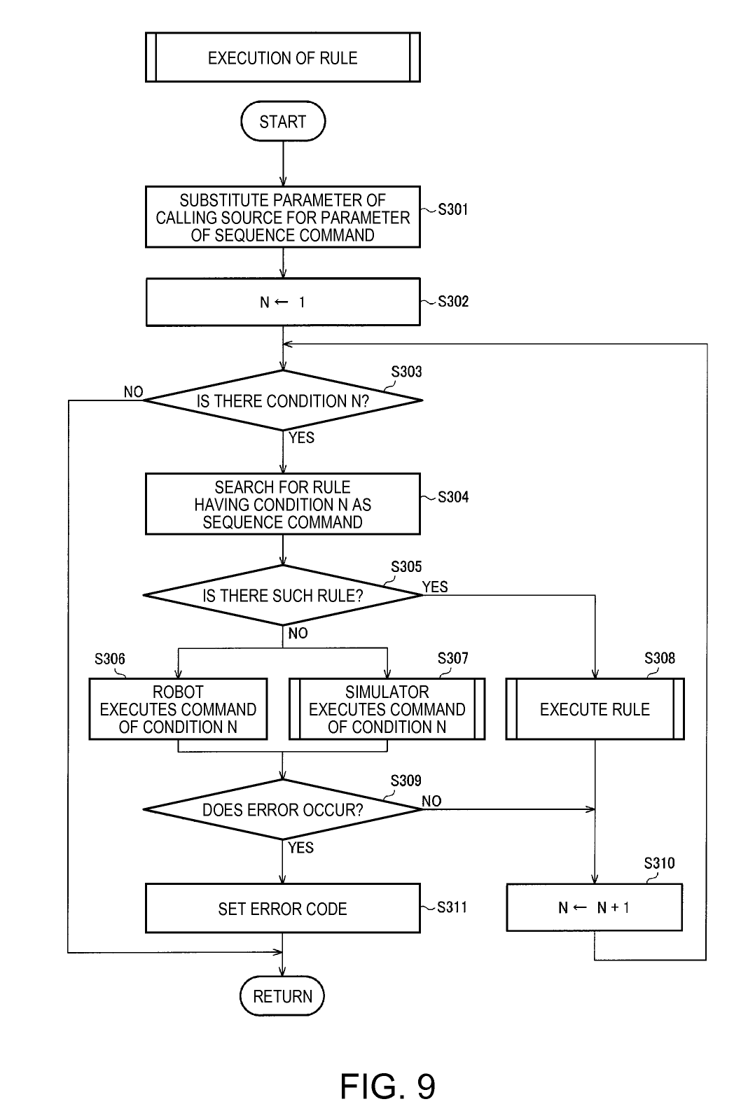

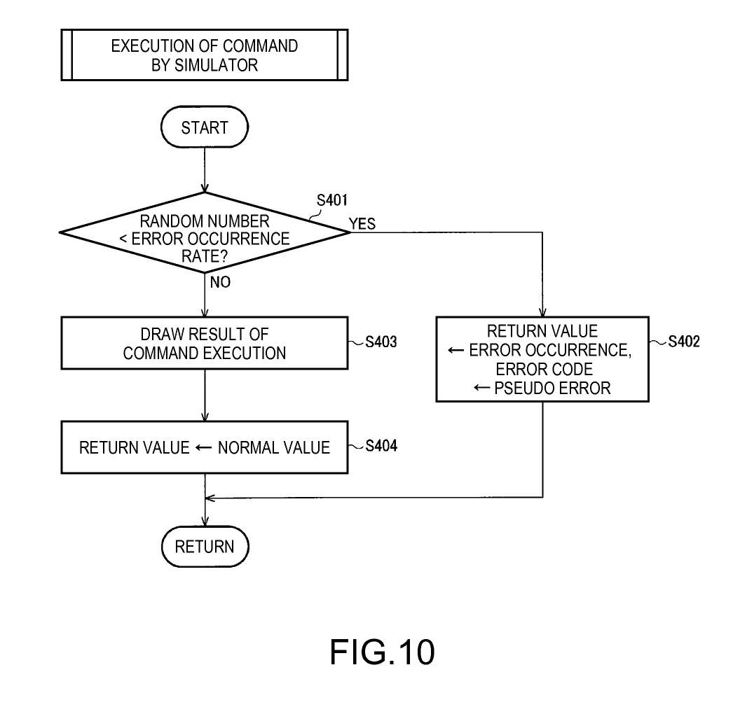

Next, the processing carried out in the robot control system according to this embodiment will be described in detail with reference to flowcharts. Specifically, overall processing will be described with reference to FIG. 7 and then execution processing of an operation instruction will be described with reference to FIG. 8. Then, execution processing of a sequence command carried out in the execution processing of an operation instruction will be described with reference to FIG. 9. Also, simulation processing by the simulation processing unit 126 will be described with reference to FIG. 10.

FIG. 7 is a flowchart showing the overall processing. As this processing starts, first, a sequence command stored in the database of the storage unit 110 (stored as a record on the command table 113) is read out (S101). Then, editing processing is carried out on the screen of FIG. 3A or the like as needed (S102) and the resulting sequence command is stored in the storage unit 110 (S103). When the editing and saving of the sequence command is completed, execution processing of the sequence command is carried out (S104). This execution processing may be done by operating the actual machine of the robot or by simulation-based confirmation of the operation.

FIG. 8 is a flowchart showing the execution processing of an operation instruction. As this processing starts, first, an operation instruction is read out (S201). This operation instruction may be a scenario as described above (that is, including one or plural sequence commands). Here, the operation instruction is assumed to be a scenario. When the scenario is read out, then a rule associating a goal of the scenario as a sequence command is searched for (S202). For example, if the scenario includes two sequence commands “Recognize the position of the workpiece (work)” and “Shift (work, point)”, first, two rules, that is, a rule having a command “Recognize the position of the workpiece (work)” as a sequence command and a rule having a command “Shift (work, point)” as a sequence command, are searched for. Whether there is a rule that satisfies the above condition is determined (S203), and when there is no such a rule, the processing ends. When there is such a rule, execution processing of the rule is carried out (S204). The execution processing of the rule refers to execution processing of a sequence command linked by the rule, which will be described in detail later with reference to FIG. 9.

Then, whether an error occurs when the rule is executed is determined (S205), and when no error occurs, the processing ends. When an error occurs, a rule having the goal corresponding to the error code as a sequence command is searched for. For example, when the error code Error0005 is sent, a rule having Error0005 as a sequence command is searched for. In this case, whether there is a rule having the goal corresponding to the error code as a sequence command is determined in S203, and when there is such a rule, the rule is executed in S204. Error processing is thus carried out.

Meanwhile, an error may occur during the error processing, and in such a case, the processing of S205, S206 and the like are carried out again.

Next, the execution processing of the rule in S204 (execution processing of the sequence command) will be described in detail with reference to FIG. 9. As this processing starts, first, the parameter of a calling source is substituted for the parameter of the sequence command. This is equivalent to setting the parameter prescribed in the operation instruction (scenario) as the parameter of the sequence command. In the case of recurrent calling in S308, the execution processing of the sequence command is carried out by execution processing of the one or plural condition commands, which is equivalent to using the parameter of the sequence command as the parameters of the condition commands.

Next, a variable N (variable indicating a condition command) is set to 1 (S302) and whether there is a condition N is determined (S303). Determining whether there is a condition N refers to determining whether there is an N-th condition command. Hereinafter, a “condition N” is assumed to refer to an N-th condition command. Then, a rule having the condition N as the sequence command is searched for (S304). When such a rule is not found, it means that the condition N is not used as the sequence command (no lower-order command exists in the hierarchical structure). Therefore, execution processing of the condition N is carried out in S306 or S307. Here, S306 is an example where the operation is carried out using the actual machine. S307 is an example where the processing is carried out by a simulator. After the processing of S306 or S307 is carried out, whether an error occurs is determined (S309). When an error occurs, an error code is set (S311) and the processing ends. When no errors occur, the processing shifts to S310.

When there is a rule having the condition N as the sequence command in S305, it means that there is the lower-order command in the hierarchical structure. Therefore, execution processing of the lower-order command is carried out and a rule execution module is called recurrently (S308). After the processing of S308, or when the determination result is No in the above S309, N is incremented (S310) and the processing returns to S303. That is, up to this point is the processing for the first condition command, and then N is incremented to start processing of the second condition command.

Finally, command execution processing by the simulator in S307 will be described with reference to FIG. 10. As this processing starts, first, a random number is generated and whether the random number is smaller than an error occurrence rate or not is determined (S401). When a result is Yes, a value equivalent to error occurrence is set as a return value of the processing. At the same time, a value of error code is set to a desired pseudo error value (this may be decided randomly) (S402).

When the result is No in S401, a result of execution of the command is drawn on a display unit of the simulator (S403) and a normal value is set as the return value of the processing (S404).

In the above embodiment, the robot control system includes the storage unit 110 which stores a sequence command, the processing unit 120 having the execution unit 122 which carries out execution processing of the sequence command stored in the storage unit 110, and the robot control unit (the robot control device 50) which controls the robot based on the result of processing by the processing unit 120, as shown in FIG. 2. The storage unit 110 stores, as the sequence command, plural normal operation sequence commands and plural error processing operation sequence commands described by the same command system as the normal operation sequence commands. The execution unit 122, at the time of normal operation, carries out execution processing of the normal operation commands, and at the time of error occurrence, carries out execution processing of an error processing operation sequence selected according to the error status.

Here, the sequence command is described by one or plural commands. Also, the feature that the normal operation sequence commands and the error processing operation sequence commands are described by the same command system means that both the normal operation sequence commands and the error processing operation sequence commands can be described using a common command group, for example, as described later.

Thus, by setting the sequence command as a set of plural commands and then using the common command system as the sequence command, both the normal operation sequence commands and the error processing operation sequence commands can be described. Moreover, at the time of normal operation, the normal operation sequence commands are executed, and at the time of error occurrence, execution processing of an error processing operation sequence command selected according to the error status from among the plural error processing operation sequence commands is carried out. Thus, since an operation instruction can be described by a link (the above-described rule) between plural commands (the above-described condition commands) and a sequence command, the operation instruction can be systematically described. Additionally, since the normal operation sequence commands and the error processing operation sequence commands can be described by the same command system, an error processing operation can be described easily and flexibly. Since the error processing operation can be described easily, plural error processing operations can be prepared easily. As an appropriate error processing operation can be selected from the plural error processing operations according to the error status, the occurrence of an error can be dealt with properly and flexibly.

In the storage unit 110, the command table 113 linking command information to a parameter indicating a processing target of the command may be stored, and also the sequence command table 115 linking a sequence command to one or plural condition commands may be stored, as shown in FIG. 2.

Here, a condition command is selected from commands stored as records on the command table 113. The condition command and the sequence command have such a relation that, by executing one or plural condition commands in order of description, a sequence command linked to the condition commands is executed.

Thus, the command table 113 and the sequence command table 115 can be realized in the database as shown in FIG. 4. In this embodiment, the link between the sequence command and the condition commands described by the sequence command table 115 is also called a rule. By associating the sequence command with the condition commands, operation instructions can be described hierarchically and systematically.

The processing unit 120, at the time of normal operation, executes one or plural condition commands constituting a normal operation sequence command, referring to the sequence command table 115 and the command table 113. Similarly, at the time of error occurrence, the processing unit 120 executes one or plural condition commands constituting an error processing operation sequence command, referring to the sequence command table 115 and the command table 113.

Thus, the normal operation sequence command and the error processing operation sequence command can be described using a common command group. That is, commands stored as records on the command table 113 can be used both for the normal operation and for the error processing operation, making no distinction between commands for the normal operation and for the error processing operation. As described above, the fact that the normal operation sequence commands and the error processing operation sequence commands are described by the same command system means, for example, that both sequence commands are described based on a common command group in this manner.

The storage unit 110 stores first to M-th (M being an integer equal to or greater than 1) command records (commands) in the command table 113 and also stores first to N-th (N being an integer equal to or greater than 2) sequence command records (rules) in the sequence command table 115. Moreover, the storage unit 110 stores the command represented by a k-th (k being an integer 1≦k≦M) command record, as the condition command, in an i-th (i being an integer 1≦i≦N) sequence command record, and also stores the command represented by the k-th command record, as the sequence command, in a j-th (j being an integer 1≦j≦N, i≠j) sequence command record.

Thus, commands stored as records on the command table 113 may be linked as sequence commands according to a certain rule and may be linked as condition commands according to another rule. Therefore, hierarchical structures with not only two hierarchical levels but also with three or more hierarchical levels are possible. That is, when a condition command is linked to a certain sequence command, the condition command also has an attribute as a sequence command and can then be linked with a further condition command below. Taking the example of FIG. 5, “Grasp (work)” is prescribed as a condition command for “Shift (work, point)”, but “Grasp (work)” itself is a sequence command and is linked with “Open hand”, “Adjust position (work)” and “Close hand” as condition commands.

The storage unit 110 also stores, as the normal operation sequence command, a first normal operation sequence command including a first approach command, a grasp command and a move command. The storage unit 110 may also store, as the error processing operation sequence command, a first error processing operation sequence command including a second approach command for approaching a different position from the first approach command, the first approach command, the grasp command and the move command.

Thus, the error processing as shown in FIGS. 6A to 6F is possible. This error processing is an example of dealing with a case where a command to shift (approach a workpiece, grasp and move the workpiece) is given as a normal operation sequence command and an error occurs (for example, the workpiece falls off or the like) during this processing. Here, by using the second approach command, an approach is made to a position different from the position designated by the first approach command. By doing so, the angle or the like at which the workpiece is grasped can be varied from the case where the normal operation sequence command is executed, as shown in FIGS. 6B and 6F. Thus, at least the error occurrence for the same reason as in the execution of the normal operation sequence command can be improved.

The robot control unit (the robot control device 50) outputs an error code corresponding to the error status to the processing unit 120. The execution unit 122 carries out execution processing of an error processing operation sequence command corresponding to the error code.

Thus, processing corresponding to the error status can be carried out by using the error code. For example, by preparing five types of error codes 0001 to 0005 as described above and associating error processing operation sequence commands Error0001 to Error0005 with the error codes, respectively, different kinds of error processing can be carried out according to the five types of error status and flexible error processing is possible. Alternatively, as described above, plural error processing operation sequence commands may be associated with one error code, and an error processing operation sequence command to be executed may be selected using the number of times the error code is called, and so on.

The processing unit 120 may include the editing processing unit 124 which carries out editing processing of the normal operation sequence command and the error processing operation sequence command, as shown in FIG. 2.

Thus, editing processing of the normal operation sequence command and the error processing operation sequence command can be carried out. For example, as described with reference to FIGS. 3A and 3B, editing processing by selecting a sequence command and condition commands from a command group (commands stored as records on the command table 113) is conceivable.

The editing processing unit 124 may use the command used in the normal operation sequence command or the error processing operation sequence command on which editing processing is carried out previously, in editing processing of the normal operation sequence command or the error processing operation sequence command of this time. Particularly, the command used in the normal operation sequence command on which editing processing is carried out previously may be used in editing processing of the error processing operation sequence command of this time, or the command used in the error processing operation sequence command on which editing processing is carried out previously may be used in editing processing of the normal operation sequence command of this time.

Thus, commands that are previously used can be utilized in editing processing of the subsequence sequence commands. Therefore, for example, as shown in the drop-down menu of FIG. 3B, a previously used command can be selected simply by pressing a button and sequence commands can be edited easily. In this case, because of the foregoing characteristic that the normal operation sequence command and the error processing operation sequence command can be described using a common command group, editing can be carried out without having to worry about whether the previous editing target is the normal operation sequence command or the error processing operation sequence command, and whether the editing target this time is the normal operation sequence command or the error processing operation sequence command.

The processing unit 120 may include the simulation processing unit 126 which carries out operation simulation processing of the robot control unit when the normal operation sequence command and the error processing operation sequence command are executed, as shown in FIG. 2.

Thus, whether the error processing operation is properly described or not can be determined without operating the actual machine of the robot. Since processing is carried out via software by the simulation processing unit 126, easy and high-speed verification is possible, compared with the case where the actual machine is used.

The simulation processing unit 126 may generate an error code corresponding to a pseudo error for confirmation of error processing.

Thus, it is possible to generate an error also in the simulation, then execute error processing corresponding to the status of the error, and verify whether the executed error processing is appropriate or not.

The embodiment also relates to a robot system including the above robot control system and a robot controlled by the robot control system.

Thus, a robot system can be realized in which the above robot control device controls the robot 30, thus enabling coordinated operations.

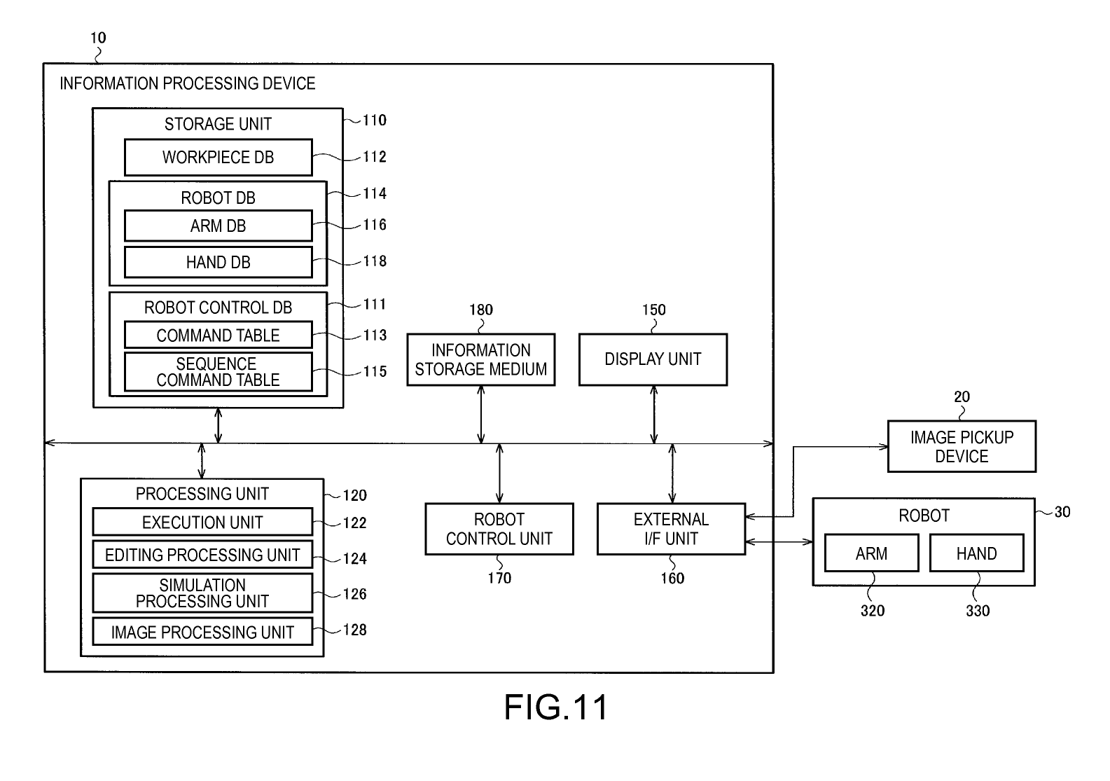

The embodiment also relates to a program which causes a computer to function as the storage unit 110 which stores a sequence command, the processing unit 120 including the execution unit 122 which carries out execution processing of the sequence command stored in the storage unit 110, and a robot control unit 170 which controls the robot based on the result of processing by the processing unit 120, as shown in FIG. 11. The storage unit 110 stores, as the sequence command, plural normal operation sequence commands and plural error processing operation sequence commands described by the same command system as the normal operation sequence commands. The execution unit 122, at the time of normal operation, carries out execution processing of the normal operation sequence commands, and at the time of error occurrence, carries out execution processing of an error processing operation sequence command selected according to the error status.

Thus, a program for carrying out processing to control the robot via software can be realized. The program is recorded on an information storage medium 180. Here, as the information storage medium 180, various recording media readable by the information processing device 10 or the like can be assumed, including optical discs such as DVD or CD, magneto-optical disks, hard disks (HDD), and memories such as non-volatile memory or RAM. For example, a case where the program is stored on various recording media readable by the information processing device of a PC or the like and then executed by the processing unit 120 is conceivable, as shown in FIG. 11.

The embodiment is described above in detail. However, those skilled in the art will easily understand that various modifications can be made without departing from the scope of the novel features and effects of the invention. Therefore, it should be considered that such modifications are included in the scope of the invention. For example, a term described together with a different term with a broader meaning or the same meaning at least once in the specification or drawings can be replaced with that different term at any point in the specification or drawings. The configurations and operations of the robot control system, the robot system and the like are not limited to those described in the embodiment and various modified embodiments are possible.

The entire disclosure of Japanese Patent Application No. 2011-100843, filed Apr. 28, 2011 is expressly incorporated by reference herein.

What is claimed is:

1. A robot control system comprising:
a storage unit which stores a sequence command described by one or plural commands;
a processing unit having an execution unit which carries out execution processing of the sequence command stored in the storage unit; and
a robot control unit which controls a robot based on a result of processing by the processing unit,
wherein the storage unit stores, as the sequence command, plural normal operation sequence commands, and plural error processing operation sequence commands described by the same command system as the commands used for description of the normal operation sequence commands, and
the execution unit at the time of normal operation, carries out execution processing of the normal operation sequence commands, and at the time of error occurrence, carries out execution processing of an error processing operation sequence command selected according to an error status, from the plural error processing operation sequence commands.

2. The robot control system according to claim 1, wherein the storage unit
stores a command table which associates command information that is information related to the commands used for description of the sequence command, with a parameter indicating a processing target of the commands, and
stores, when a condition command and the sequence command from among the commands have such a relation that the sequence command is executed by execution of one or a plurality of the condition commands, a sequence command table which associates the one or plurality of the condition commands with information related to the sequence command.

3. The robot control system according to claim 2, wherein the processing unit
at the time of the normal operation, executes the one or plural condition commands constituting the normal operation sequence command, referring to the sequence command table and the command table, and
at the time of the error occurrence, executes the one or plural condition commands constituting the error processing operation sequence command, referring to the sequence command table and the command table.

4. The robot control system according to claim 2, wherein the storage unit stores first to M-th (M being an integer equal to or greater than 1) command records in the command table and stores first to N-th (N being an integer equal to or greater than 2) sequence command records in the sequence command table, and
the storage unit stores the command represented by a k-th (k being an integer 1≦k≦M) command record, as the condition command, in an i-th (i being an integer 1≦i≦N) sequence command record, and stores the command represented by the k-th command record, as the sequence command, in a j-th (j being an integer 1≦j≦N, i≠j) sequence command record.

5. The robot control system according to claim 1, wherein the storage unit stores, as the normal operation sequence command, a first normal operation sequence command including a first approach command, a grasp command and a move command, and stores, as the error processing operation sequence command, a first error processing operation sequence command including a second approach command for approaching a different position from the first approach command, the first approach command, the grasp command and the move command.

6. The robot control system according to claim 1, wherein the robot control unit outputs an error cord corresponding to the error status to the processing unit, and
the execution unit carries out execution processing of the error processing operation sequence command corresponding to the error code.

7. The robot control system according to claim 1, wherein the processing unit includes an editing processing unit which carries out editing processing of the normal operation sequence command and the error processing operation sequence command.

8. The robot control system according to claim 7, wherein the editing processing unit uses the command used in the normal operation sequence command or the error processing operation sequence command on which editing processing is carried out previously, in editing processing of the normal operation sequence command of this time or another error processing operation sequence command.

9. The robot control system according to claim 8, wherein the editing processing unit uses the command used in the normal operation sequence command on which editing processing is carried out previously, in editing processing of the error processing operation sequence command of this time.

10. The robot control system according to claim 8, wherein the editing processing unit uses the command used in the error processing operation sequence command on which editing processing is carried out previously, in editing processing of the normal operation sequence command of this time.

11. The robot control system according to claim 1, wherein the processing unit includes a simulation processing unit which carries out operation simulation processing of the robot control unit when the normal operation sequence command and the error processing operation sequence command are executed.

12. The robot control system according to claim 11, wherein the simulation processing unit generates an error code corresponding to a pseudo error for confirmation of error processing.

13. A robot system comprising:
the robot control system according to claim 1; and
a robot controlled by the robot control system.

14. A robot system comprising:
the robot control system according to claim 2; and
a robot controlled by the robot control system.

15. A robot system comprising:
the robot control system according to claim 3; and
a robot controlled by the robot control system.

16. A robot system comprising:
the robot control system according to claim 4; and
a robot controlled by the robot control system.

17. A robot system comprising:
the robot control system according to claim 5; and
a robot controlled by the robot control system.

18. A robot system comprising:
the robot control system according to claim 6; and
a robot controlled by the robot control system.

19. A robot system comprising:
the robot control system according to claim 7; and
a robot controlled by the robot control system.

20. A program causing a computer to function as
a storage unit which stores a sequence command described by one or plural commands,
a processing unit having an execution unit which carries out execution processing of the sequence command stored in the storage unit, and
a robot control unit which controls a robot based on a result of processing by the processing unit,
wherein the storage unit stores, as the sequence command, plural normal operation sequence commands, and plural error processing operation sequence commands described by the same command system as the commands used for description of the normal operation sequence commands, and
the execution unit at the time of normal operation, carries out execution processing of the normal operation sequence commands, and at the time of error occurrence, carries out execution processing of an error processing operation sequence command selected according to an error status, from the plural error processing operation sequence commands.
